(19) United States
(12) Patent Application Publication
(10) Pub. No.: US 2009/0282390 A1
(43) Pub. Date: Nov. 12, 2009

(54) Parallel Run-Time Rendering Debugger

(75) Inventor: Lewey Alec Geselowitz, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/117,658

(22) Filed: May 8, 2008

(51) Int. Cl. G06F 9/44

(52) U.S. Cl. 717/127

(57) ABSTRACT

Systems and methods are disclosed for debugging the graphical output of a software program. This may be achieved both by displaying the graphical output of the software program at intermediary stages of the graphical rendering process, and by visually representing the interdependencies found within the software code of the program.

### BACKGROUND OF THE INVENTION

In graphical software applications, the graphical rendering code, which writes values into a display or intermediary buffer for users to see, is often complicated, hard to understand and even harder to debug, or to visualize the intermediary steps and results thereof. The graphical rendering code can be difficult to debug because it is executed very frequently (for example, texture blending code is often executed on a per-pixel basis, which requires millions of evaluations per second, spread across the output display), or because visual effects are time-based, so properly debugging them requires analysis of those millions of evaluations while the application is running.

Thus, the debugging process of graphical rendering code can be improved upon by allowing for debugging a great number of values at once, in a visual manner. Some of these techniques may be generalized to aid debugging computer code in general.

### SUMMARY OF THE INVENTION

In example embodiments of the present disclosure, a method is provided for visually debugging a plurality of graphics values in an executing application. This method may include, but does not require, a user using a visual user interface that allows the user to connect to an executing application, select a portion of the graphics rendering code therein, and then visually display that code within the application's existing user interface framework.

To render a graphics frame, an application typically builds the frame up by adding one or more rendering layers to a wireframe image. For example, a layer may be a graphics texture applied to the surface of a wireframe, or a lighting effect, such as the light that is present on objects because of the Sun in an outdoor scene during the daytime. In a typical use, the user selects a graphics instruction that comprises an intermediary level of the graphics processing process and the graphics frame is displayed at that point. For example, where the graphics processing process comprises adding a wood texture to a wireframe representation of a desk, then rendering the light emanating from a lamp on the desk, followed by rendering the light emanating through the window and then rendering the light emanating from the lights in the ceiling, an instruction could be selected such that the graphics frame displayed in the user interface would include the rendering process only up through rendering the light emanating from the lamp. In this way, individual steps in the rendering process may be more carefully examined. A user may wish to examine such an intermediary step in the process to see whether a computationally expensive rendering step adds enough to the frame to make the cost worthwhile. A common optimization exposed by the present method is uncovering an instruction that outputs the same value across an entire wireframe, but that requires a large amount of computational work. This is commonly caused by shader programs that can perform a wide variety of functions, and in the present case contain a large amount of special-case code that is not being utilized.

The debugging works by dynamically modifying the application being debugged. It replaces the visual output of the selected code with an intermediary value from within the code, based on a selection in the user interface. In this way, multiple executions of an algorithm, such as a pixel shader executed over many pixels, can be debugged at once by having each pixel output an intermediary value generated during its rendering, thus achieving massively parallel debugging with almost no performance impact on the application. The process of dynamic modification can be done at interactive rates, allowing a user to efficiently browse through large amounts of rendering code, quickly seeing the values read and written at each point. The tool provides a huge usability jump over previous debugging methods that generally required the application to be paused and executed step-by-step, allowing the debugger time to read the values it is looking for and display them to the user in a separate interface. This pitfall is avoided by having the debug output flow into existing display channels.

A system is also disclosed that performs comparable functions as the method discussed above.

In example embodiments of the present disclosure, a method is provided for selecting a first instruction within the executing application, wherein the first instruction assigns an intermediary value to a variable, determining at least one other instruction, wherein said other instruction is one of the set that comprises an instruction that affects the value of the first instruction and an instruction that is affected by the value of the first instruction; and displaying the rendering instruction, the other instruction, and an indication that the rendering instruction and the other instruction are interconnected.

The user interface graphs out the code as a dependency tree, allowing the user to quickly see not only the values generated in the code, but also to see for a particular value which parts of the code contributed to it, and which were affected by it. In this way, the user is able to quickly determine how the code is interrelated.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

The systems, methods, and computer readable media for both visually debugging a plurality of graphics values in an executing application, and debugging an executing application by producing a dependency tree in accordance with this specification are further described with reference to the accompanying drawings in which:

FIG. 1 illustrates an example operating environment in which operating procedures may be performed.

FIG. 2 illustrates an example operational procedure for visually debugging a plurality of graphics values in an executing application.

FIG. 3 illustrates an example operational procedure for debugging an executing application by producing a dependency tree.

FIG. 4 illustrates an example user interface for using the method of FIG. 3, which includes the results of those operations.

FIGS. 5A and 5B illustrate a graphics frame at different stages of the rendering process.

### DETAILED DESCRIPTION OF ILLUSTRATIVE EMBODIMENTS

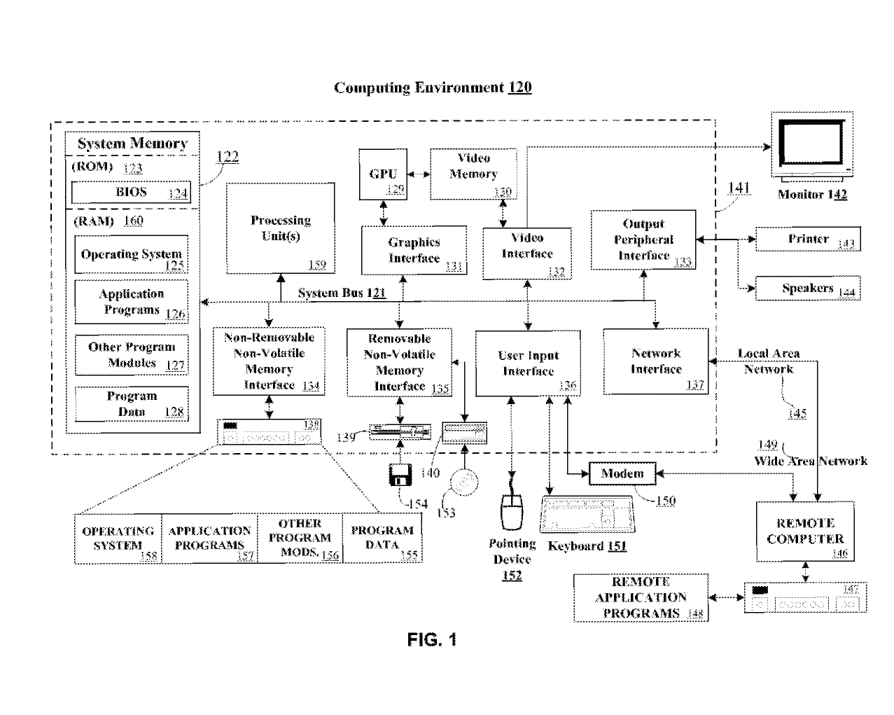

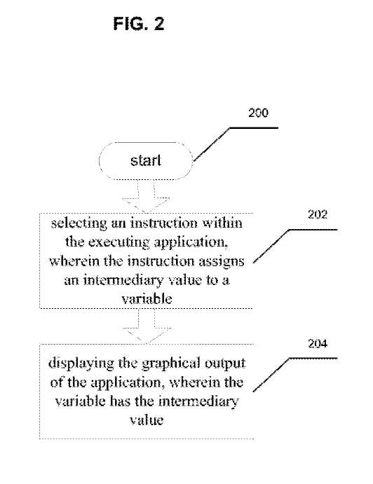

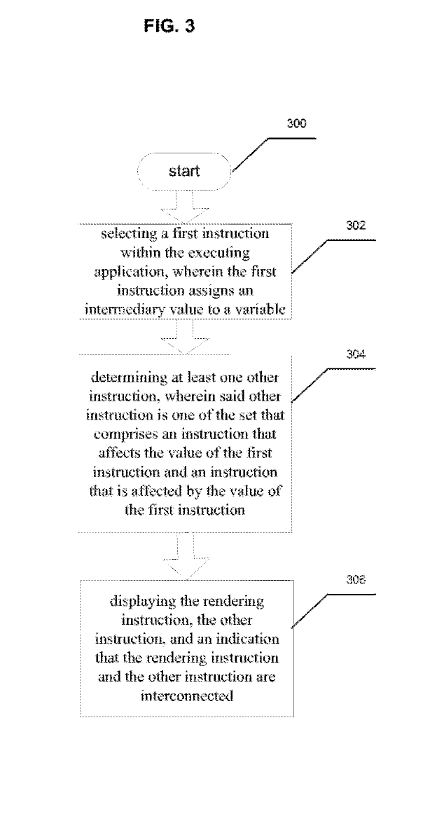

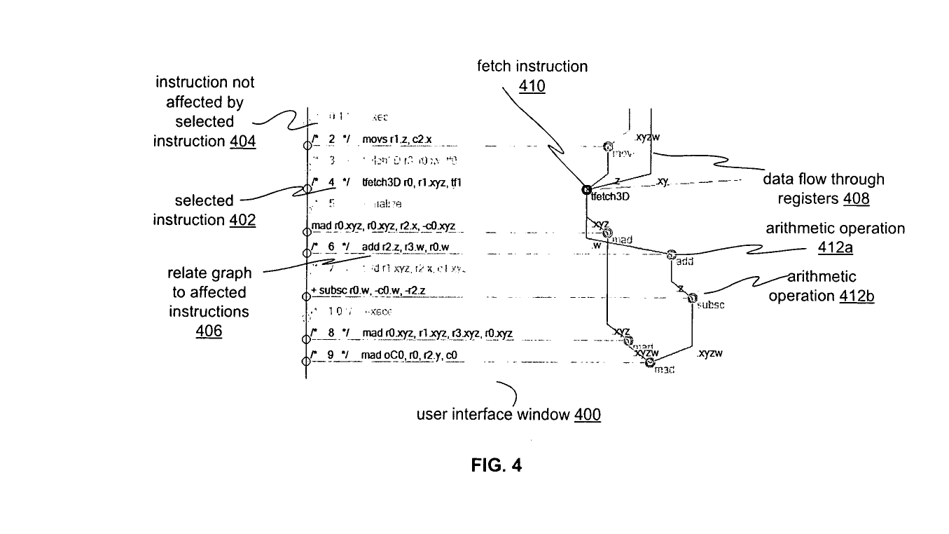

Certain specific details are set forth in the following description and figures to provide a thorough understanding of various embodiments. Those of ordinary skill in the relevant art will understand that they can practice other embodiments without one or more of the details described below. While various methods are described with reference to steps and sequences in the following disclosure, the description as such is for providing a clear implementation of embodiments of the invention, and the steps and sequences of steps should not be taken as required. FIG. 1 illustrates an operating environment in which operating procedures may be performed. FIGS. 2-3 depict example operating procedures. FIG. 4. depicts an example user interface for using the method of FIG. 3, which includes the results of those operations.

FIG. 1 illustrates an exemplary system for implementing aspects of the presently disclosed subject matter, including a general purpose computing device in the form of a computer 141. Components of computer 141 may include, but are not limited to, a processing unit 159, a system memory 122, a graphics processing unit 129 (and a graphics interface 131), a video memory 130 (and a video interface 132), and a system bus 121 that couples various system components including the system memory 122 to the processing unit 159. The system bus 121 may be any of several types of bus structures, including a memory bus or memory controller, a peripheral bus, and a local bus using any of a variety of bus architectures. By way of example and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 141 typically includes a variety of computer-readable media. Computer-readable media can be any available media that can be accessed by computer 141, and includes both volatile and nonvolatile media, removable and non-removable media. By way of example and not limitation, computer-readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), electronically erasable programmable read-only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 141.

Communication media typically embodies computer readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example and not limitation, communication media includes wired media such as a wired network or direct-wired connection, and wireless media such as acoustic, RF, infrared and other wireless media. Combinations of the any of the above should also be included within the scope of computer readable media.

The system memory 122 includes computer storage media in the form of volatile and/or nonvolatile memory such as read only memory (ROM) 123 and random access memory (RAM) 160. A basic input/output system 124 (BIOS), containing the basic routines that help to transfer information between elements within computer 141, such as during start-up, is typically stored in ROM 123. RAM 160 typically contains data and/or program modules that are immediately accessible to and/or presently being operated on by processing unit 159. By way of example and not limitation, FIG. 1 illustrates operating system 125, application programs 126, other program modules 127, and program data 128.

The computer 141 may also include other removable/non-removable, volatile/nonvolatile computer storage media. By way of example only, FIG. 1 illustrates a hard disk drive 138 that reads from or writes to non-removable, nonvolatile magnetic media, a magnetic disk drive 139 that reads from or writes to a removable, nonvolatile magnetic disk 154, and an optical disk drive 140 that reads from or writes to a removable, nonvolatile optical disk 153 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 138 is typically connected to the system bus 121 through a non-removable memory interface such as interface 134, and magnetic disk drive 139 and optical disk drive 140 are typically connected to the system bus 121 by a removable memory interface, such as interface 135.

The drives and their associated computer storage media discussed above and illustrated in FIG. 1 provide storage of computer readable instructions, data structures, program modules and other data for the computer 141. In FIG. 1, for example, hard disk drive 138 is illustrated as storing operating system 158, application programs 157, other program modules 156, and program data 155. Note that these components can be either the same as or different from operating system 125, application programs 126, other program modules 127, and program data 128. Operating system 158, application programs 157, other program modules 156, and program data 155 are given different numbers here to illustrate that, at a minimum, they are different copies. A user may enter commands and information into the computer 141 through input devices such as a keyboard 151 and pointing device 152, commonly referred to as a mouse, trackball or touch pad. Other input devices (not shown) may include a microphone, joystick, game pad, satellite dish, scanner, or the like. These and other input devices are often connected to the processing unit 159 through a user input interface 136 that is coupled to the system bus, but may be connected by other interface and bus structures, such as a parallel port, game port or a universal serial bus (USB). A monitor 142 or other type of display device is also connected to the system bus 121 via an interface, such as a video interface 132. In addition to the monitor, computers may also include other peripheral output devices such as speakers 144 and printer 143, which may be connected through an output peripheral interface 133.

The computer 141 may operate in a networked environment using logical connections to one or more remote computers, such as a remote computer 146. The remote computer 146 may be a personal computer, a server, a router, a network PC, a peer device or other common network node, and typically includes many or all of the elements described above relative to the computer 141, although only a memory storage device 147 has been illustrated in FIG. 1. The logical connections depicted in FIG. 1 include a local area network (LAN) 145 and a wide area network (WAN) 149, but may also include other networks. Such networking environments are commonplace in offices, enterprise-wide computer networks, intranets and the Internet.

When used in a LAN networking environment, the computer 141 is connected to the LAN 145 through a network interface or adapter 137. When used in a WAN networking environment, the computer 141 typically includes a modem 150 or other means for establishing communications over the WAN 149, such as the Internet. The modem 150, which may be internal or external, may be connected to the system bus 121 via the user input interface 136, or other appropriate mechanism. In a networked environment, program modules depicted relative to the computer 141, or portions thereof, may be stored in the remote memory storage device. By way of example and not limitation, FIG. 1 illustrates remote application programs 148 as residing on memory device 147. It will be appreciated that the network connections shown are exemplary and other means of establishing a communications link between the computers may be used.

FIG. 2 illustrates a method for visually debugging a plurality of graphics values in an executing application. Those skilled in the art will note that the elements are illustrative in purpose and that different implementations can select appropriate elements for such implementations.

Operation 200 begins the method. Operation 200 may be triggered, for example, by opening a computer application that performs the steps of the present method, where that application then establishes communication with the application to be debugged.

Operation 202 depicts selecting an instruction within the executing application, wherein the instruction assigns an intermediary value to a variable. In an embodiment, a list of the application's source code is presented in a window, and an instruction is selected by a user clicking on it with a mouse pointer, or using other input devices to achieve the same result. This list of the application's source code may be read from the application itself. In an embodiment, this source code appears in assembly language form. In another embodiment, this source code appears in high-level programming language form, such as C++ instructions.

In an embodiment, this selected instruction is a graphics rendering instruction that affects the graphical output of the executing application. In an embodiment, this selected instruction further comprises a graphics shader instruction.

In an embodiment, said selecting comprises selecting the instruction from a plurality of instructions that represent the executing application in assembly language.

In an embodiment, said application executes continuously. Many debuggers necessitate the use of breakpoints, so that the debugged application executes only in the chunks of code between those breakpoints. The present method of visual debugging may be facilitated by continuously executing the program because that allows a user to accurately observe how the modified graphics change over time.

In an embodiment, the application executes on a first computing device, the step of selecting takes place on a second computing device, and the two computing devices inter-communicate. The communication may take place over an internet connection, a universal serial bus (USB) connection, or the like.

Operation 204 depicts displaying the graphical output of the application, wherein the variable has the intermediary value. For example, the intermediary value may reflect a graphics value after some lighting shaders have been executed, but before other lighting shaders have been executed. In this case, the graphical output will display this partially lit frame. The user may then examine this frame

FIG. 3 illustrates a method for debugging an executing application by producing a dependency tree. Those skilled in the art will note that the elements are illustrative in purpose and that different implementations can select appropriate elements for such implementations.

Operation 300 begins the method. Operation 300 may be triggered, for example, by opening a computer application that performs the steps of the present method, where that application then establishes communication with the application to be debugged.

Operation 302 depicts selecting a first instruction within the executing application, wherein the first instruction assigns an intermediary value to a variable. In an embodiment, a list of the application's source code is presented in a window, and an instruction is selected by a user clicking on it with a mouse pointer, or using other input devices to achieve the same result. This list of the application's source code may be read from the application itself. In an embodiment, this source code appears in assembly language form. In another embodiment, this source code appears in high-level programming language form, such as C++ instructions.

In an embodiment, the first instruction comprises a graphics rendering instruction. In an embodiment, the first instructions further comprises a shader instruction.

Operation 304 depicts determining at least one other instruction, wherein said other instruction is one of the set that comprises an instruction that affects the value of the first instruction and an instruction that is affected by the value of the first instruction. In an embodiment, the first instruction reads the value of a variable and the other instruction previously sets a value for that variable. In an embodiment, the first instruction writes the value of a variable, and the other instruction later reads the value for that variable.

Operation 306 depicts displaying the rendering instruction, the other instruction, and an indication that the rendering instruction and the other instruction are interconnected.

In an embodiment, said indication is a graphical indication.

In an embodiment, said displaying includes displaying an indication that said other instruction is a fetch instruction.

In an embodiment, said displaying includes displaying an indication that said other instruction is an arithmetic operation.

In an embodiment, said instructions operate upon registers, and said displaying includes displaying an indication of how the data operated upon by said instructions flows through said registers.

In an embodiment, determining a third instruction, wherein said third instruction is outside of the set that comprises an instruction that affects the value of the first instruction and an instruction that is affected by the value of the first instruction, and displaying an indication that said third instruction is outside of said set.

In an embodiment, said displaying includes displaying an indication that said first instruction is the selected instruction.

In an embodiment, the first instruction operates upon a control flow register, and said displaying includes displaying an indication that the first instruction operates upon the control flow register.

In an embodiment, said first instruction and said other instruction each operate upon a constant, and said displaying includes displaying an indication that said constant is a constant.

In an embodiment, the application has a user interface and displaying the graphical output of the application includes displaying the graphical output of the application in the application's user interface. For instance, where the application. In this situation, one may execute the application as normal, including using the application's standard output display, but with the graphical output as modified by this method.

FIG. 4 illustrates an example user interface for using the method of FIG. 3, which includes the results of those operations. A user interface window 400 may be used to display the list of instructions and the dependency graph generated by the selected instruction 402. This window 400 may be a subpart of a larger user interface that allows a user to utilize the methods described above. The selected instruction 402 is heavily underlined to differentiate it from other instructions involved in the dependency graph, and a different color than instructions not affected by the selected instruction 404. Data flow through registers 408 used by the selected instruction 402 and instructions affected by the selected instruction is shown via a line on the right hand side of the window. A fetch instruction is denoted in the data flow graph via a dark circle placed at the point where it occurs 410. Arithmetic operations are denoted in the data flow graph via a lightly-colored circle placed at the point where they occur 412a, 412b. The use of color in this user interface may greatly increase the ability of the user to make quick use of the information contained therein.

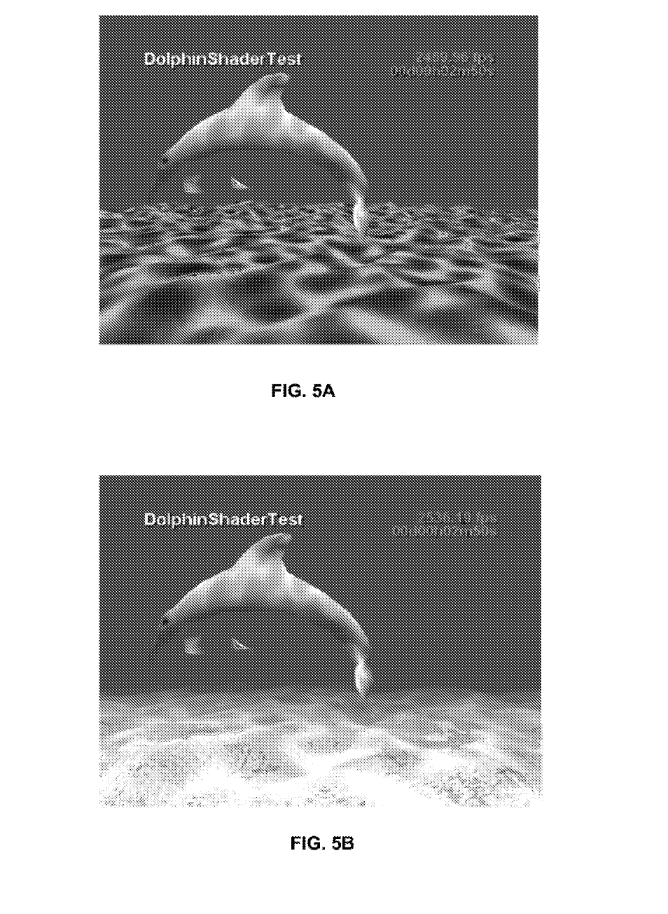

FIG. 5 illustrates a graphics frame at different stages of the rendering process. In FIG. 5a, only the secular highlight on the chest is shown. In FIG. 5b, the chest has been rendered in full, including the secular highlight of FIG. 5a. Given this, the user may compare the two images along with the source code responsible for creating the secular highlight and determine whether that is a satisfactory result in exchange for the computational work required to produce it.

### CONCLUSION

While the present disclosure has been described in connection with the preferred aspects, as illustrated in the various figures, it is understood that other similar aspects may be used or modifications and additions may be made to the described aspects for performing the same function of the present disclosure without deviating therefrom. Therefore, the present disclosure should not be limited to any single aspect, but rather construed in breadth and scope in accordance with the appended claims. For example, the various procedures described herein may be implemented with hardware or software, or a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

What is claimed:

1. A method for visually debugging a plurality of graphics values in an executing application, comprising:
selecting an instruction within the executing application, wherein the instruction assigns an intermediary value to a variable;
displaying the graphical output of the application, wherein the variable has the intermediary value.

2. The method of claim 1, wherein the instruction is a graphics rendering instruction.

3. The method of claim 1, wherein the application has a user interface and displaying the graphical output of the application includes displaying the graphical output of the application in the application's user interface.

4. The method of claim 1, wherein the application executes on a first computing device, said selecting takes place on a second computing device, and said first computing device and said second computing device inter-communicate.

5. The method of claim 1, wherein said selecting comprises selecting the instruction from a plurality of instructions that represent the executing application in assembly language.

6. The method of claim 1, wherein the application executes continuously.

7. The method of claim 1, wherein the instruction comprises a shader instruction.

8. A method for debugging an executing application by producing a dependency tree, comprising:
selecting a first instruction within the executing application, wherein the first instruction assigns an intermediary value to a variable;
determining at least one other instruction, wherein said other instruction is one of the set that comprises an instruction that affects the value of the first instruction and an instruction that is affected by the value of the first instruction; and
displaying the rendering instruction, the other instruction, and an indication that the rendering instruction and the other instruction are interconnected.

9. The method of claim 7, wherein said indication is a graphical indication.

10. The method of claim 7, wherein said displaying includes displaying an indication that said other instruction is a fetch instruction.

11. The method of claim 7, wherein said displaying includes displaying an indication that said other instruction is an arithmetic operation.

12. The method of claim 7, wherein said instructions operate upon registers, and said displaying includes displaying an indication of how the data operated upon by said instructions flows through said registers.

13. The method of claim 7, further comprising:
determining a third instruction, wherein said third instruction is outside of the set that comprises an instruction that affects the value of the first instruction and an instruction that is affected by the value of the first instruction; and
displaying an indication that said third instruction is outside of said set.

14. The method of claim 7, wherein said displaying includes displaying an indication that said first instruction is the selected instruction.

15. The method of claim 7, wherein the first instruction operates upon a control flow register, and said displaying includes displaying an indication that the first instruction operates upon the control flow register.

16. The method of claim 7, wherein said first instruction and said other instruction each operate upon a constant, and said displaying includes displaying an indication that said constant is a constant.

17. The method of claim 7, wherein the first instruction comprises a graphics rendering instruction.

18. The method of claim 17, wherein the first instructions further comprises a shader instruction.

19. The method of claim 7, wherein said instructions comprise assembly language instructions.

20. A system for visually debugging a plurality of graphics values in a continuously executing application, comprising:
connecting to the executing application, wherein said application executes on a first computing device;
selecting, on a second computing device, an instruction within the executing application from a plurality of instructions that represent the executing application in assembly language, wherein the instruction assigns an intermediary value to a variable, and wherein the instruction is a graphics rendering instruction;
displaying the graphical output of the application, wherein the variable has the intermediary value, in the application's user interface.
